(19) United States
(12) Patent Application Publication
(10) Pub. No.: US 2006/0041670 A1
(43) Pub. Date: Feb. 23, 2006

(54) Method, computer system and computer program product for executing a network supported business transaction

(75) Inventors: Johannes Musseleck, Worms (DE); Jurgen Ahlers, Gross-Rohrheim (DE); Hermann Eichert, Frankenstein (DE); Kerim Wewer, Mannheim (DE); Reinhard Katz, Bad Durkheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/207,786

(22) Filed: Aug. 22, 2005

(30) Foreign Application Priority Data
Aug. 20, 2004 (EP) 04019777.4

(51) Int. Cl. G06F 15/16

(52) U.S. Cl. 709/229

(57) ABSTRACT

The invention relates to a method for executing a network supported customer business transaction and a method for providing access to an access protected area of a server, in which in each case access to the access protected area in the server by the client terminal is granted when an access authorization is electronically activated.

### CROSS-REFERENCE TO RELATED APPLICATIONS

This application is based upon and claims the benefit of priority from the prior European Patent Application No. 04019777.4, filed Aug. 20, 2004, the entire contents of which is incorporated herein by reference.

### BACKGROUND OF THE INVENTION

1. Field of the Invention

The present invention relates generally to the protected exchange of information. In particular, the present invention relates to a method, a computer system and computer program product for carrying out or executing a network supported business transaction as well as a method for providing access to an access protected area of a server and an electronically activatable access authorization.

2. Discussion of the Background

In modern communication between companies, the cost-efficient integration of business transactions between business partners constitutes a major challenge.

A data transmission between Enterprise Resource Planning (ERP) systems by means of Electronic Data Interchange (EDI) is, for example, already known. Concepts such as these are based on a bi-directional integrated communication between business partners. They necessitate exact agreements about the data formats to be exchanged, for which an appropriate “mapping” is required. Because of the start-up costs generated in this process, this type of integration is in many cases uneconomic.

For this reason some businesses make information available to business partners on an internet portal to give their business partners the opportunity to view the information within the internet portal or input information into the internet portal. In inputting the information, expenses nevertheless arise for the business partner which they may not necessarily be prepared to bear.

For this reason, in the past years so-called “light integration possibilities” have been developed that integrate unidirectional business transactions. A business partner (for example a customer) sends a business transaction, for example electronically, to another business partner (for example the supplier), and this business transaction is automatically taken into the supplier's system. In this way, mapping expenses are produced on one side only. Such a solution is practical, for instance, in markets with a high concentration on one of the two sides, since one business partner is the counterpart of many others and economies of scale can be leveraged.

A response or confirmation from the supplier to the customer takes place normally by e-mail or fax, i.e. is not integrated. The information content of such confirmation is usually less than the information content available via the internet portal, in which it is often possible to resort to a multitude of data items from the ERP system.

### SUMMARY OF THE INVENTION

The present inventors have determined that there is a need for a more secure and reliable method and a computer system for carrying out or executing a network supported business transactions and for providing access to an access protected area of a server and an electronically activatable access authorization.

In the method according to the present invention, a network supported business transaction is executed by taking the following steps in response to receiving a request at a server that originates from a client terminal:
defining an access protected area in the server allocated to the request;
generating an electronically activatable access authorization which includes an addressing of the access protected area; and
transmitting the access authorization to the client terminal from which the request originates;
   wherein access to the access protected area by the client terminal takes place by the electronic activation of the access authorization. The defining of an access protected area in the server allocated to the request encompasses both the generation of an area not previously present, thus a new access protected area and also the confirmation or correct assignation of an access protected area already present.

Accordingly, the method relates to a secure data communication between the server and the client terminal, irrespective of how many additional servers, clients, computers, calculating units, networks such as internet, worldwide web or an intranet these are connected to the system. The access protected area is stored in the server and/or generated therein.

The term “Client terminal” should be understood in the broadest possible sense within the framework of the present application, that is to say an independent apparatus or one forming a part of a larger system with which an inquiry can be sent to a server prepared according to the invention via any network (intranet, internet, LAN, etc). The request can be generated manually or automatically in this process. For example, the client terminal may be part of an ERP system belonging to the inquiring business partner.

The term “business partner” should be understood within the framework of the present invention to mean both external customers and/or clients of the provider as well as internal customers and/or clients of the provider (thus, for instance, clients from another business area of the same company).

In this way, a secure and reliable network supported and/or web based exchange of information is possible for a user of the client terminal as well as for a service provider. Despite the high level of security for the access protected area, the communication between the client terminal and the server or the user/customer and the provider can be carried out by various known communication techniques.

For the client terminal, or a user of the client terminal, a comfortable and secure access to the access protected area of the server is allowed. The client can communicate with the server or the provider operating and/or using the server at least partially by exchanging information via the access protected area. Independently of the business transaction, a secure network supported exchange of information is possible with the method described herein.

The request can be a business transaction such as, for example, an order. However, other services can be provided via the access protected area, and these services can support the business transaction and also serve the supplier/provider and the customer or accompany the business transaction. Other services may include, for example, an exchange of detailed information about goods on offer or services, complaints, billing, transactions of a financial nature and other similar matters.

With regard to addressing, this can be a matter of, for example, posting, filing, attachment, connection, access possibility or a reference to the latter or a procedure involving the access protected area, in which the access protected area is made accessible to the client terminal through electronically activating the access authorization (which includes addressing) via the network, for instance, in a portal of the server. A so-called “shared folder” can also be provided as addressing, which may be accessible for both sides, i.e. for the customer and for the provider and may contain alterable information.

The addressing can be constructed in a manner suitable to the structure of the network or the type of the data transfer between the client terminal and the server within the network. The addressing also depends on the type of software and/or hardware used to provide the communication between the client terminal and the server, and its function as a junction or interface between the network and the user or customer and provider. The addressing ensures, independently of a concrete form, that between the client terminal and the server a unidirectional or bi-directional, passive or active exchange of data or information is possible.

In the described methods it can be envisaged, independently from a type of addressing, that the access authorization is activated by or via the client terminal and therefore it is by or via the client terminal that the access protected area is opened.

The client terminal can be any device suitable for the transmission of electronic data, in particular a computer or a suitable calculating or processing unit. It is also conceivable however that a client terminal could be a telephone, for instance a mobile telephone, or possibly a media sending and receiving device suitably equipped to exchange data.

It can on the one hand be envisaged, that for the user or the customer for whom the access authorization or the access protected area is conceived and who has transmitted the request via the client terminal, the access protected area would be opened with the access authorization transmitted from one and the same device only.

On the other hand, it can also be possible that access to the access protected area is offered to the user by the client terminal by at least one device, thus also different devices, through electronic activation of the access authorization. In this case the at least one device embodying the client terminal can be, for example, different computers or other devices suitable for exchanging data electronically, as discussed above. Typically, an application for the transmission of data like an e-mail program or internet browser is installed in such devices. In this case, the electronically activatable access authorization is made available and manageable to the user according to a specific authorization for this application.

The term customer may also refer to an organization of customers consisting of a plurality of persons. Thus, access to the access protected area with the access authorization is also possible for each person within the customer organisation.

From the client terminal, login is possible with the electronically activatable access authorization without inputting a user name and codeword into the access control area of the server. With the electronically activatable access authorization, an authorization or a key for the access protected area is available to the user for whom the access protected area is provided. In these circumstances, the electronically activatable access authorization includes a suitable coding or data record.

For the user or the customer it is thus possible to call up/retrieve and/or input information concerning the business transaction at any time via secure access to the area (for example in the portal of the server).

Another embodiment of the present invention envisages the electronically activatable access authorization being available by, or as, a hyperlink. By using the hyperlink, it is possible to establish a connection between a first hypertext within which the hyperlink is contained, and a second hypertext. This second hypertext is, for example, an internet page within the access protected area. The connection in this case is made, for example, via an internet browser. The realization of the invention is possible via any form of link in any form of electronic document.

In carrying out the method, it can be provided that the electronically activatable access authorization is established by access to a file, for instance a login information file by the addition of specific login files encoded in a personalized URL. The personalized URL is decoded with this access authorization by resorting to the file or login information files, and the access to the access protected area is opened.

These measures enable a secure coding of the access protected area of the server and reliable decoding of this access protected area.

Furthermore, the electronically activatable access authorization may be transmitted in an electronic message, such as an e-mail which is exchanged between the server and the client terminal. In the framework of the business transaction, this electronic message is transmitted to the customer by the provider after receipt of certain information relevant to the business transaction, for instance a commission document which was submitted at the beginning of the business transaction.

The access protected area can be opened by clicking on the hyperlink, a text mark or a text symbol. Accordingly, secure entry to the access protected area is available to the partner or the customer.

It is also possible that the hyperlink, when presented as pure text, may be copied into an entry list or data entry field of an internet browser. It can be so arranged that the electronically activatable access authorization comprising a code for access is present as a text file, a graphic image, as an electronic medium or in the form of another, possibly encoded file. In this case, access authorization is copied into an entry field, for example on an internet page, whereby the access into the access protected area of the server is securely provided.

Initially, the user or customer transmits, via the client terminal to the server used or run by the provider, the request containing, for example, data formatted information. After the receipt of this request, the business transaction is created in an ERP system of the provider, which may be connected to the server. In the processing of this business transaction, an electronic message and access authorization are produced, preferably automatically. The customer may than receive a confirmation and the electronically activatable access authorization for his designated business area or one appropriate to the current business transaction. The customer is then able to access this access protected area of the provider's portal to receive information about the progress of the business transaction.

The present invention also includes a computer system for a network supported exchange of information in response to a request received at the server, which originated from a client terminal. In processing the transaction, the system performs the flowing steps:
defining, by the server, an access protected area assigned/allocated to the request;
generating an electronically activatable access authorization including an address of the access protected area; and
transmitting the access authorization to the client terminal from which the request originates,
   and access to the access protected area of the server occurs via electronic activation of the access authorization.

The computer system may include an ERP (Enterprise Resource Planning) system connected with the portal which is designed for the receipt and transmission of data, particularly electronic messages. ERP systems serve in EDP supported handling of a high volume of business transactions that become necessary within companies connected to one another.

The computer system can, for example, be a server-client terminal network system. The network can be the internet, the worldwide web, or an intranet. It is conceivable that the system itself is also conceived as a network or as a part of a network.

In the server, the following steps are executed as a reaction to an input request originating from the at least one client terminal:
defining, in the server, an access protected area assigned to the request;
generating an electronically activatable access authorization including an addressing to the access protected area; and
transmitting the access authorization to the client terminal from which the request originates;
   wherein access to the access protected area of the server takes place through electronic activation of the access authorization.

With this server, a communication from a user or customer with the client terminal and with a provider, who at least partly operates the server and/or uses it, is realizable.

The electronically activatable access authorization can include an address of an access protected area in the server. With this electronic activatable access authorization, through electronic activation, a connection with and access to the access protected area is obtainable.

With this access authorization a key is available for entry into the access protected area without the need to input user name and codeword. By inputting the access authorization and/or activation of the access authorization, access to the access protected area of the portal is allowed. In this connection, the access authorization can be provided at least partially with a coding which is present as, for example, a data record or a coding. With the access authorization, the number of times a user is able to gain access to protected area may be customized.

The electronically activatable access authorization can be realized as a part of a link, for example of a hyperlink, or can be realized completely as a link. The access authorization can be equipped with a link and therefore be constructed in such a way that it contains written and/or graphic pieces of information. Alternatively, the electronically activatable access authorization may be built as any copyable, user operated, copyable without destruction, non-copyable, non-user-operated, encoded, non encoded, or may be a computer file, for example a text file or a graphics file.

The specific login data encoded in a personalized URL may be appended or added to the electronically activatable access authorization through accessing a computer file which may include, for example, login information. Accordingly, a link to the personalized URL and/or the access protected area is generated upon the creation of the access authorization. Through activation or use of this access authorization the access protected area can be opened

The access protected area can be directly or indirectly localized on a computer or a suitable calculation unit of a provider of goods, information or services, i.e. The access protected area can also be used by the provider when using the server of a service provider on which the access protected area is stored.

In another embodiment of the present invention, a method for providing access to an access protected area in a portal of a server include the following steps in response to a request transmitted to the server, which originates from a client terminal:
define the access protected area assigned to the request in the server portal;
generate an electronically activatable access authorization including an address of the access protected area; and
transmit the access authorization to the client terminal from which the request originates.
   With this method it is possible to enable access to a protected area within a portal of the server.

The electronically activatable access authorization can be formed as a hyperlink, or part of a hyperlink. The electronically activatable access authorization can be generated by resorting to a computer file, for example, a login information file by adding specific login data encoded in a personalized URL. Access to the access protected area is opened by the personalized URL with the electronically activatable access authorization being decoded by referring to the computer file.

The electronically activatable access authorization can be communicated in an electronic message, for example, an e-mail. The access protected area can accessed by clicking on or other suitable activation of the hyperlink. Together with the request sent from the client terminal to the server, file formatted information are and other information is transmitted. In particular, a request from a customer is transmitted from the client terminal to the server of a provider. Departing from this request, a business transaction is generated in an ERP system of the provider. Confidential information pertaining to the business transaction which is updated during the business transaction can be consulted in a confidential manner by the customer. Specifically, by starting from the client terminal by opening the access protected area assigned to him by means of the electronically activatable access authorization. It is also conceivable that through the request, a link is made to an already existing business transaction, so that this business procedure which is already existing is updated or possibly reactivated through the request.

It goes without further saying that the invention comprehends computer programs with program code suitable to carry out a method according to the invention by the running of the computer program, as well as to computer readable data carrying media with computer programs according to the invention stored thereon and to computer program products with computer readable data carrying media.

It will be understood that the above named and the below still to be explained features are utilizable not only in the individually given combination, but also in other combinations or on their own, without leaving the framework of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a diagram of an information exchange accompanying a business transaction according to the background art;

FIG. 2 shows a diagram of an embodiment of an information exchange according to one embodiment of the present invention.

FIG. 3 shows in a schematic representation a server-client terminal system according to one embodiment of the present invention; and

FIG. 4 illustrates a computer system upon which the computer systems of the present invention may be implemented.

### DESCRIPTION OF THE PREFERRED EMBODIMENTS

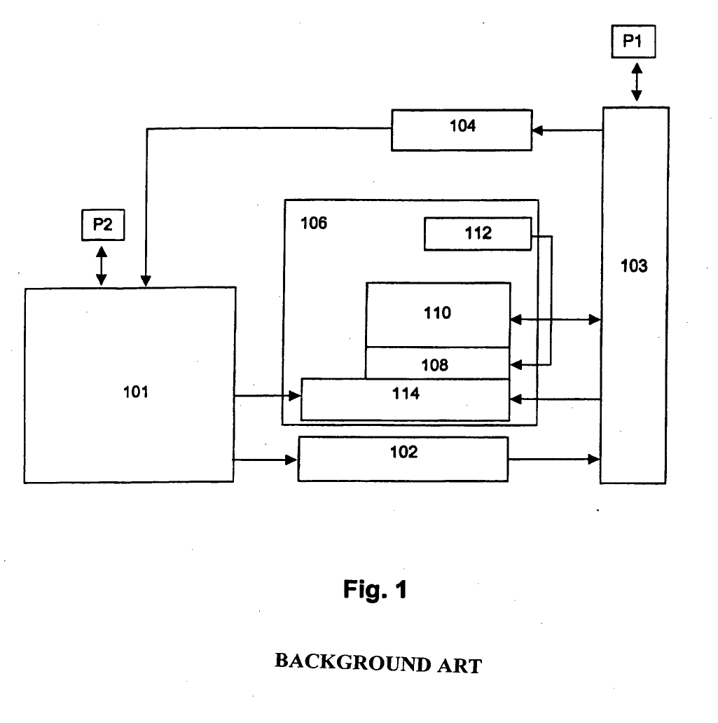

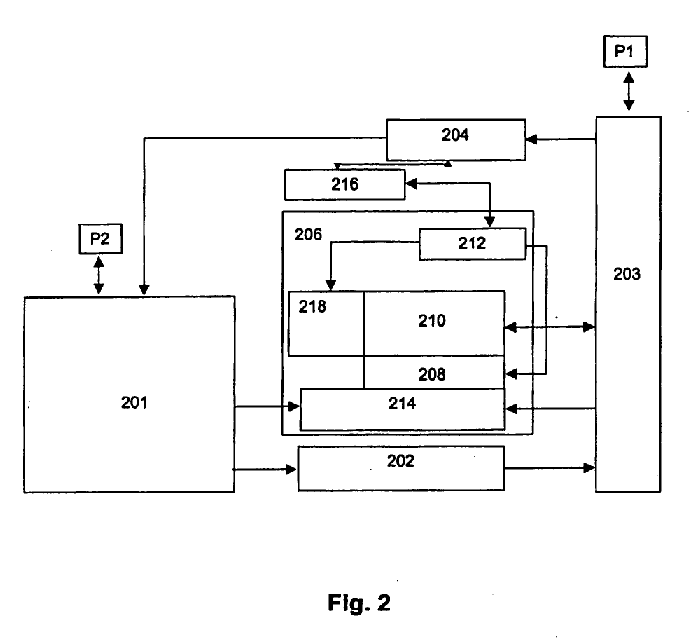

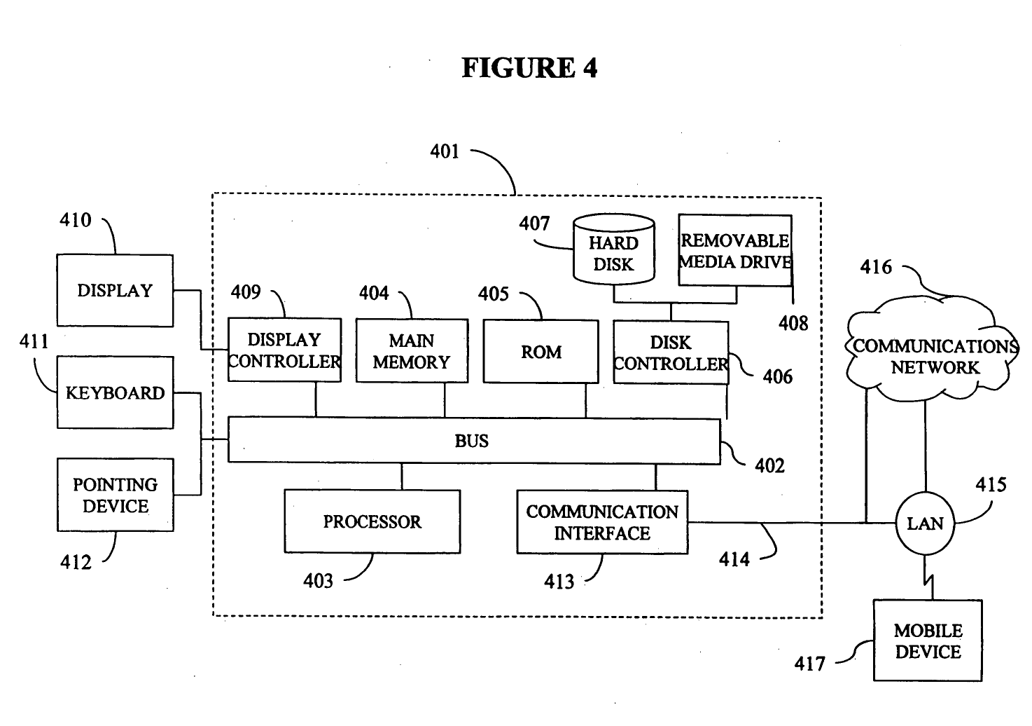

Referring to the drawings, wherein like reference numerals designate identical or corresponding parts through the several views, FIG. 1 shows in schematic representation a known arrangement for the conducting of a business transaction from the point of view of a first business partner, P1. A second business partner, a customer, user or inquirer, P2 transmits a business transaction in the form of an order 102 to an ERP system 103 of the provider P1, via computer system 101 by way of a so-called light integration tool. A mapping takes place, either with or without the use of for example artificial intelligence, semantic text recognition and similar facilities. On the basis of this the business transaction is generated in the ERP system 103 of the provider P1. The computer system 101 of the second business partner is a computer network system which can include a number of components (some of which are depicted in FIG. 4), for instance a central processing unit, a local area network server, a number of client terminals, an ERP system, as well as peripheral machines like printers, monitors etc. As the second business partner generally communicates via a client terminal, the text below will describe the computer system 101 as well as the computer system 201, in FIG. 2, as client terminal. It should also be understood that the business transaction is automatically initiated by the ERP system of the computer system.

Within the framework of the processing of the business transaction there is an acknowledgement or confirmation 104 that is formatted and transmitted to the client terminal 101, typically by electronic means. The acknowledgement 104 can be, for example, an order confirmation containing an order number connected to the business transaction from the ERP system 103 of the provider P1.

The customer P2 may eventually require more information about the business transaction. To retrieve this information, internet portal 106 which is available by the provider P1 can be used. Generally, information about business transactions is not found in a public area 114, but is instead in an access protected area 110 of the internet portal 106.

To access this access protected area 110, the customer P2 logs in via the client terminal 101 via a manual login 108 by inputting a user name and codeword. The login information is then compared with information stored in a computer file or data bank 112 and access to the access protected area is granted. The customer P2 is then able to obtain information relevant to the business transaction from, for example, the ERP system 103 of the provider P1. This information may, for example, concern the processing status of an order.

FIG. 2 shows in schematic representation of one embodiment of the present invention considering, for example, a procedure for carrying out a secure communication between two partners in the context of a business transaction, the two partners being a provider P1 and a customer P2.

An ERP system 203 of a provider P1 is connected to a server of the provider P1. This server has a portal 206, for example an internet portal which contains a public area 214 accessible for all users, and an access protected area 210 which is closed to the public and is accessible by, for example, manual login.

At the beginning of the business transaction, the customer (or user or inquirer) P2 transmits, via a client terminal 201, a request or an order 202 to the server of the provider P1 by, for example, a light integration tool. In doing so, a mapping takes place either with or without the use of, for example, artificial intelligence, semantic text recognition or any other similar mapping technique. The business transaction can then be generated in the ERP system 203 of the provider P1.

This business transaction is processed, during which a formatted acknowledgement 204 is produced and sent from the server to the client terminal 201 of the customer P2. This acknowledgement 204 includes information corresponding to the business transaction initiated by the order 202. The acknowledgment includes, for example, an order confirmation including a number of a procedure or order connected to the business transaction from the ERP system 203 of the provider P1.

If the client P2 wants to receive more information about the business transaction, he can request this information from the portal 206 using the client terminal 201. This client terminal 201 can be any computer or any suitable calculating unit with appropriate software for the web based exchange of data (see FIG. 4, for example).

During the generation and/or transmission of the acknowledgment 204 of the provider P1 to the customer P2, customer specific or process specific login data 216 is gtenerated by referring to a computer file, for example a login information file 212. This procedure can also occur within the ERP system 203. The login data 216 is encoded in a personalized URL, and an electronically activatable access authorization to the access protected area 210 of the server is made available to the client terminal 201 of the customer P2. After receipt of the acknowledgment 204, the customer P2 can use this URL with the electronically activatable access authorization. If the acknowledgement 204 is sent by e-mail to the client terminal 201 of the customer P2, the access authorization is transmitted in a link appended to the e-mail, specifically a hyperlink or an enclosure containing a link.

If the customer P2 then wants to receive information about the business transaction, he clicks on the hyperlink containing the electronically activatable access authorization. The customer P2 is then connected with the portal 206 via the client terminal 201 or his network connection, for instance via an internet service program (browser). Within the portal 206, the personalized URL is decoded (manually or automatically). The decoding is performed by resorting to the same data file or login information data file 212 used in the encoding, or by resorting to a replica of this login information file 212.

For the customer or user P2, this means that access to his personalized access protected area 210 is offered without inputting a user name and codeword into the client terminal 201. He can immediately be conducted through or transferred to the information relevant to the business transaction made available, for example, from the ERP system 203 of the provider P1.

Access to the access protected area 210 is then provided for the customer or business partner P2 via an automatic login 218, by linking with the URL through the client terminal 201 from the activated hyperlink. The information about the access protected area 210 can correspond in a procedure specific way with the content of the acknowledgment 202.

Alternatively, a manual login 208 can also be provided. This may occur after the customer P2 arrives at a site on the portal 206 on which specific or goal-oriented information is offered.

According to another embodiment of the invention, the acknowledgment 204 may include several sets of login data 216 that are added to the message of the provider P1 to the client terminal 201 of the customer P2. In this case links are prepared for various pieces of information, and an additional safeguard is possible by the use of cookies, other signatures etc.

Accordingly to the present invention, it is possible to realize a bi-directional communication in connection with a business transaction based on a unidirectional mapping.

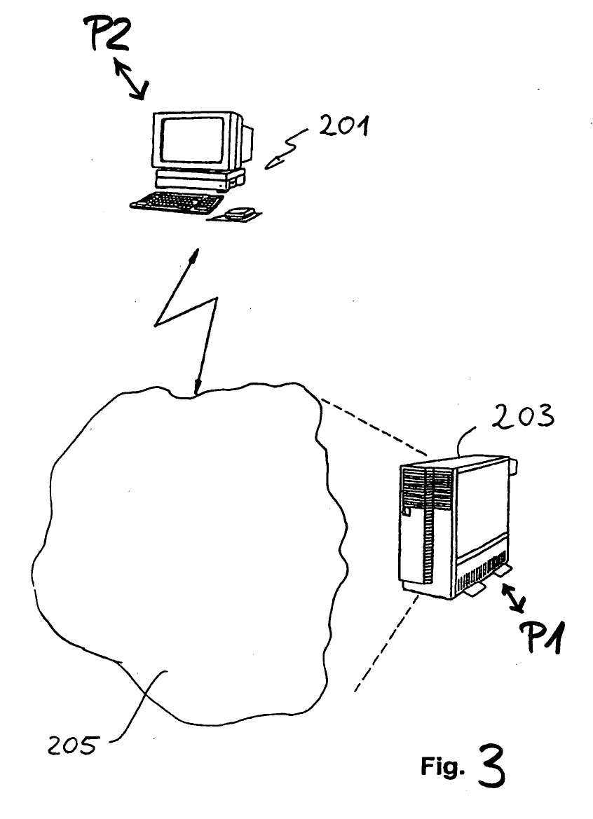

FIG. 3 shows a schematic representation of a client-server terminal system through which the business transaction between two partners, a provider P1 and a client P2, can be processed. A client terminal 201, normally a computer, is allocated to the customer P2. A server 203 is allocated to the provider P1. The client terminal 201 and the server 203 are connected to one another via a network 205 for the mutual exchange of information. Within the scope of the invention it is conceivable that several networks 205 as well, as for example a telephone network or fax network and the world wide web, are used.

When carrying out the method according to the invention, the customer P2 sends a request to the server 203 of the provider P1 from the client terminal 201 via the network 205. In response, an access protected area allocated to the request is generated in the server 203. Further, an electronically activatable access authorization including an address of the access protected area is generated. This electronically activated access authorization is transmitted by the server 203 via the network 205 to the client terminal 201 from which the request proceeds. An access to the access protected area on the server 203 by the client terminal 201 happens by the electronic activation of this access authorization.

FIG. 4 illustrates a computer system 401 upon which an embodiment of the present invention may be implemented. The computer system 401 includes a bus 402 or other communication mechanism for communicating information, and a processor 403 coupled with the bus 402 for processing the information. The computer system 401 also includes a main memory 404, such as a random access memory (RAM) or other dynamic storage device (e.g., dynamic RAM (DRAM), static RAM (SRAM), and synchronous DRAM (SDRAM)), coupled to the bus 402 for storing information and instructions to be executed by processor 403. In addition, the main memory 404 may be used for storing temporary variables or other intermediate information during the execution of instructions by the processor 403. The computer system 401 further includes a read only memory (ROM) 405 or other static storage device (e.g., programmable ROM (PROM), erasable PROM (EPROM), and electrically erasable PROM (EEPROM)) coupled to the bus 402 for storing static information and instructions for the processor 403.

The computer system 401 also includes a disk controller 406 coupled to the bus 402 to control one or more storage devices for storing information and instructions, such as a magnetic hard disk 407, and a removable media drive 408 (e.g., floppy disk drive, read-only compact disc drive, read/write compact disc drive, compact disc jukebox, tape drive, and removable magneto-optical drive). The storage devices may be added to the computer system 401 using an appropriate device interface (e.g., small computer system interface (SCSI), integrated device electronics (IDE), enhanced-IDE (E-IDE), direct memory access (DMA), or ultra-DMA).

The computer system 401 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 401 may also include a display controller 409 coupled to the bus 402 to control a display 410, such as a cathode ray tube (CRT), for displaying information to a computer user. The computer system includes input devices, such as a keyboard 411 and a pointing device 412, for interacting with a computer user and providing information to the processor 403. The pointing device 412, for example, may be a mouse, a trackball, or a pointing stick for communicating direction information and command selections to the processor 403 and for controlling cursor movement on the display 410. In addition, a printer may provide printed listings of data stored and/or generated by the computer system 401.

The computer system 401 performs a portion or all of the processing steps of the invention in response to the processor 403 executing one or more sequences of one or more instructions contained in a memory, such as the main memory 404. Such instructions may be read into the main memory 404 from another computer readable medium, such as a hard disk 407 or a removable media drive 408. One or more processors in a multi-processing arrangement may also be employed to execute the sequences of instructions contained in main memory 404. In alternative embodiments, hard-wired circuitry may be used in place of or in combination with software instructions. Thus, embodiments are not limited to any specific combination of hardware circuitry and software.

As stated above, the computer system 401 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 401, for driving a device or devices for implementing the invention, and for enabling the computer system 401 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 403 for execution. A computer readable medium may take many forms, including but not limited to, non-volatile media, volatile media, and transmission media. Non-volatile media includes, for example, optical, magnetic disks, and magneto-optical disks, such as the hard disk 407 or the removable media drive 408. Volatile media includes dynamic memory, such as the main memory 404. Transmission media includes coaxial cables, copper wire and fiber optics, including the wires that make up the bus 402. Transmission media also may also take the form of acoustic or light waves, such as those generated during radio wave and infrared data communications.

Various forms of computer readable media may be involved in carrying out one or more sequences of one or more instructions to processor 403 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 401 may receive the data on the telephone line and use an infrared transmitter to convert the data to an infrared signal. An infrared detector coupled to the bus 402 can receive the data carried in the infrared signal and place the data on the bus 402. The bus 402 carries the data to the main memory 404, from which the processor 403 retrieves and executes the instructions. The instructions received by the main memory 404 may optionally be stored on storage device 407 or 408 either before or after execution by processor 403.

The computer system 401 also includes a communication interface 413 coupled to the bus 402. The communication interface 413 provides a two-way data communication coupling to a network link 414 that is connected to, for example, a local area network (LAN) 415, or to another communications network 416 such as the Internet. For example, the communication interface 413 may be a network interface card to attach to any packet switched LAN. As another example, the communication interface 413 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 413 sends and receives electrical, electromagnetic or optical signals that carry digital data streams representing various types of information.

The network link 414 typically provides data communication through one or more networks to other data devices. For example, the network link 414 may provide a connection to another computer through a local network 415 (e.g., a LAN) or through equipment operated by a service provider, which provides communication services through a communications network 416. The local network 414 and the communications network 416 use, for example, electrical, electromagnetic, or optical signals that carry digital data streams, and the associated physical layer (e.g., CAT 5 cable, coaxial cable, optical fiber, etc). The signals through the various networks and the signals on the network link 414 and through the communication interface 413, which carry the digital data to and from the computer system 401 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 401 can transmit and receive data, including program code, through the network(s) 415 and 416, the network link 414 and the communication interface 413. Moreover, the network link 414 may provide a connection through a LAN 415 to a mobile device 417 such as a personal digital assistant (PDA) laptop computer, or cellular telephone.

Obviously, numerous additional modifications and variations of the present invention are possible in light of the above teachings. It is therefore to be understood that within the scope of the appended claims the present invention may be practiced otherwise than as specifically described herein.

1-25. (canceled)

26. A method for executing a network supported business transaction over a network, comprising:
transmitting a request for information from a client terminal to a server;
defining, within the server, an access protected area allocated to the request;
generating, at the server, an electronically activatable access authorization including an address of the access protected area; and
transmitting the access authorization from the server to the client terminal, wherein the client terminal is configured to access the access protected area by via electronic activation of the access authorization.

27. The method of claim 26, wherein:
the electronically activatable access authorization is a hyperlink.

28. The method of claim 26, wherein:
the electronically activatable access authorization is produced at the server by accessing a file including specific login data, and the specific login data is encoded in a personalized URL.

29. The method of claim 28, further comprising:
decoding, at the server, the personalized URL including the electronically activatable access authorization by accessing the file including specific login data; and
granting access to the access protected area.

30. The method of claim 26, wherein:
the electronically activatable access authorization is transmitted in an electronic message.

31. The method of claim 27, further comprising:
opening the access protected area by clicking on the hyperlink with the electronically activatable access authorization.

32. The method according to claim 26, wherein the step of transmitting a request further comprises:
transmitting data formatted information together with the request.

33. A system configured to support a networked exchange of information, comprising:
a client terminal configured to generate a request for information;
a server configured to
receive the request for information from the client terminal;
define an access protected area allocated to the request;
generate an electronically activatable access authorization including an address of the access protected area; and
transmit the access authorization to the client terminal from the server; and
the client terminal configured to access the access protected area of the server by electronically activating the access authorization.

34. The system of claim 33, further comprising:
an Enterprise Resource Planning (ERP) system connected to the server.

35. The system of claim 34, wherein:
the ERP system is configured to transmit and receive data.

36. A method for providing access to an access protected area of a server in response to an incoming request in the server, the request originating from a client terminal connected to the server, comprising:
defining, within the server, an access protected area allocated to the request;
generating, at the server, an electronically activatable access authorization including an address of the access protected area; and
transmitting the access authorization to the client terminal from which the request originates.

37. The method of claim 36, wherein:
the electronically activatable access authorization is formed as a hyperlink.

38. The method of claim 36, wherein:
the electronically activatable access authorization is produced at the server by accessing a file including specific login data, and the specific login data is encoded in a personalized URL.

39. The method of claim 38, further comprising:
decoding, at the server, the personalized URL including the electronically activatable access authorization by accessing the file including specific login data; and
granting access to the access protected area.

40. The method of claim 36, wherein:
the electronically activatable access authorization is transferred in an electronic message.

41. The method of claim 37, further comprising:
opening the access protected area by clicking on the hyperlink with the electronically activatable access authorization.

42. The method according to claim 36, wherein the step of transmitting a request further comprises:
transmitting data formatted information together with the request.

43. A computer program product including a computer readable medium having stored thereon computer executable instructions for executing a network supported business transaction over a network, when executed, said computer readable instructions performing steps, comprising:
receiving a request for information from a client terminal;
defining an access protected area allocated to the request;
generating an electronically activatable access authorization including an address of the access protected area; and
transmitting the access authorization to the client terminal, wherein the client terminal is configured to access the access protected area by via electronic activation of the access authorization.

44. A system for executing a network supported business transaction over a network, comprising:
means for transmitting a request for information;
means for receiving the request for information;
means for defining an access protected area allocated to the request;
means for generating an electronically activatable access authorization including an address of the access protected area; and
means for transmitting the access authorization to the means for transmitting, wherein the means for transmitting is configured to access the access protected area by via electronic activation of the access authorization.
